(19) United States
(12) Patent Application Publication
(10) Pub. No.: US 2014/0282148 A1
(43) Pub. Date: Sep. 18, 2014

(54) Monitoring and Collaborative Analysis of a Condition

(71) Applicants: Thomas Blomseth Christiansen, New York, NY (US); Mette Dyhrberg, Brooklyn, NY (US)

(72) Inventors: Thomas Blomseth Christiansen, New York, NY (US); Mette Dyhrberg, Brooklyn, NY (US)

(21) Appl. No.: 13/844,642

(22) Filed: Mar. 15, 2013

(51) Int. Cl. G06F 3/0481

(52) U.S. Cl. CPC G06F 3/0481
USPC 715/765

(57) ABSTRACT

The disclosed technology relates to computer hardware and software systems for variably monitoring a condition relating to a first user, receiving data relating to the condition, and for facilitating the collaborative analysis of the captured data by presenting a second user with an interface for reviewing the data. The text, drawings and claims of the disclosure detail various additional embodiments of the disclosed methods, systems, and computer products.

### BACKGROUND

### Field of Invention

The present technology relates to computer hardware and software systems for variably monitoring a user's condition and facilitating collaborative analysis of the resulting data. The text, drawings and claims of the disclosure detail various additional embodiments of the disclosed methods, systems, and computer products.

### SUMMARY

A computer implemented method identifying a causal relationship between a target condition affecting a first party and at least one monitored condition, by facilitating collaboration between the first party and a second party for the purpose of evaluating data related to possible relationships between the target condition and at least one monitored condition.

The disclosed technology facilitates collaboration, between a first party and a second party, for the purpose of identifying correlations, testing hypothesis and isolating causal relationships, and for adjusting the causal factors to achieve a desired result. The disclosed technology also provides a method of active monitoring and capture of data relating to a user, wherein the process of active monitoring promotes a desired behavioral change the user.

The disclosed technology also facilitates the exchange of observed data between a first user and a second user, and the collaborative testing of hypotheses that correlate monitored data to the status of the first party.

In various additional aspects, related systems include computer hardware, computer circuitry and programming for effecting the disclosed method. The computer hardware, computer circuitry and programming can be virtually any combination of hardware and software, configured to effect the disclosed method aspects.

### BRIEF DESCRIPTION OF THE DRAWINGS

Various embodiments of the invention are disclosed in the following detailed description and accompanying drawings.

FIG. 1 illustrates a high-level process flowchart.

FIG. 2 illustrates a map of suggested conditions relating to a first user.

FIG. 3 illustrates a high-level block diagram of certain system components.

FIG. 4 illustrates a view of a user interface.

FIG. 5 illustrates a view of a food-sensor interface.

FIG. 6 illustrates a view of a camera function of a food-sensor interface.

FIG. 7 illustrates an exemplary data stream.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### DEFINITIONS

Except where otherwise indicated, the following definitions apply. However, this is not an exhaustive glossary. Other definitions may be providing in-line in the disclosure.

Sensor.

Sensor is defined broadly, and includes any device or method used by the system to accept data, whether actively or passively. Sensors may receive data including: image capture, text entry, time data, geographic location data, bloodwork results, urine sample analysis, data regarding a user's mood or feelings, and other data relating to a target condition or other physical or mental condition relating to a user.

Passive Sensor.

A passive sensor collects data without the user's active participation.

Active Sensor.

An active sensor requires some direct user data entry engagement or activity to capture data.

Coach.

Coach refers to any type of advisor or medical practitioner, including medical doctors, scientists, health coaches, psychologists, psychiatrists, personal trainers, etc.

Computer-Readable Medium

is broadly defined to include any kind of computer memory, including, hard disks, solid state drives, flash drives, CDs and DVDs, and RAM.

### SUMMARY OF COMPONENTS

FIG. 1 illustrates an overview and high-level process flowchart of a preferred embodiment. A first user and a second user begin to engage with the system by mapping 101 the known facts and circumstances relating to the first user's situation 105, and to the context 103 in which the condition arises. Next, the users may derive a hypothesis 107 or series of hypotheses to explain the condition. Next, the system prompts the users to enter a series of topics 109 related to at least one hypothesis. Next, the system provides a method of receiving observations 111 from the first user. Observations may include both active data entry by a user and through passive data collection. After sufficient observations are entered into the system, the system allows the users to compare the observations to the hypothesis, and, if necessary to iterate and derive new hypothesis.

### Analysis, Map

FIG. 2 illustrates an exemplary map of conditions relating to a first user. The map provides a useful tool for organizing common factual scenarios and preparing to relate them to a target condition. The system may receive data relating to the target condition, and to the first user's overall condition.

The disclosed system may receive the results of a preliminary analysis of one or more target-conditions. The preliminary analysis may be received from at least a first party, and may include at least one initial observation and at least one initial hypothesis or preliminary-causal-relationship between a target-condition and a second condition. Topic, as used herein, refers to a second condition that may or may not have a causal relationship with the target condition.

In a preferred embodiment, a coach conducts a preliminary analysis through a meeting or interview with a user. A user provides preliminary information to the coach. In some embodiments, the system provides the coach with a categorized list of questions to facilitate the preliminary analysis process. Such a categorized list may include, for example:
a. Performance. Performance information identifies the gaps between the user's current health situation and the user's preferred health situation.
b. Intake. Intake information identifies what the user is eating, drinking, taking as dietary supplements, as medication, smoking, or otherwise ingesting.
c. Activity. Activity information identifies the physical activities engage in by the user. These may include, for example, work, walking, exercise, commuting, gym workouts and other physical activity. It may also include identifying how much time the user spends doing sedentary activities like watching television, using a computer, sleeping, and participating in other low-energy activities.
d. Environment. Environmental information identifies the external physical, chemical, social and emotional influences applied to the user at home, work, at social events, and other common locations.
e. Body Function. Body function information identifies how the user's body is functioning. It may include information regarding how well the overall bodily processes are running, including digestion, mental processes, and sleep, as well as symptoms like pain or anxiety.

In a preferred embodiment, the coach, after gathering initial information, develops at least one hypothesis. The coach may also develop a series of several hypotheses.

The system receives at least one topic 301. As used herein, “topic” means a category of data to be monitored by at least one user. In a preferred embodiment, the system receives at least one topic that is useful in proving or disproving a proposed cause of the target condition.

Correlating data collection to specific monitored topics, rather than a generalized collection of standardized data, facilitates efficient data collection. Narrowly focusing the data collection reduces data entry burden on the user, and results in more consistent data entry.

Buttons 303 are physical representations of topics. Buttons may include a state 305 that represents the relationship between the topic and an expectation related to that topic. The system may also provide a user with feedback 307 related to expectations.

Topics may also be associated with sensors 309. Sensors provide various methods of collecting data related to a topic.

Topics may also have one or more expectations 311 associated with the topic, as discussed in detail below.

Where several hypotheses are developed, the disclosed system may arrange the hypothesis into a matrix. The matrix structure facilitates comparison between competing hypothesis. A matrix structure for the analysis of competing hypothesis is disclosed in Psychology of Intelligence Analysis, Richards J. Heuer, Jr. (Center for the Study of Intelligence, Central Intelligence Agency, 1999) and hereby incorporated by reference (specifically, see chapter 8, “Analysis of Competing Hypotheses”). In the disclosed embodiment, the matrix lists hypotheses across a first axis, and topics or expectations across a second axis.

### Expectations

The system may also receive at least one “expectation.” An expectation is a goal for a behavior related to a topic.

In some embodiments, after gathering preliminary information, the coach may set at least one “expectation” for the user. The expectation identifies a topic that the user will study. The user may use the embodiment of the disclosed system to collect data on the topic.

In such an embodiment, expectations are representations of user behavior or some other physical event or occurrence. Expectations may be set for quality of data entry. Expectations may also be set for quantity of data entry.

The system may receive expectations from a number of different sources. For example, the system may receive an expectation or a series of expectations from a coach, from a user, from another source, or it may generate a set of expectations based on existing population data.

In some embodiments, frequency of user engagement with a topic is itself an expectation. For example, the expectation may be that the user record data regarding her mood 8 times per day.

### User Interface

FIG. 4 illustrates a user interface for an exemplary embodiment.

The system receives user data through at least one sensor. A sensor may include, for example, a user interface 401 with a plurality of buttons 403. The system may receive data through both active and passive sensors, and combined sensors that incorporate aspects of both manual and passive sensors.

In the exemplary embodiment, the user interface depicts sensors for three topics, Caffeine, Sugar, and Optimism. Selecting a topic-button allows the user to directly input data relating to that topic. Sensors may also provide for a comments field allowing for arbitrary data entry. The buttons may include a label 407, an outline 403, 409 and a numerical value 405. Depending on the state, a display feature of the button may change. For example, the outline may change color or become a dashed line 409 when an expectation is not met.

The interface may also provide various navigation buttons that present the user with a history 413 of recorded data and various additional topics 411.

Active sensors and manual data entry, such as the topic-buttons discussed above, provides certain advantages over passive sensors. Active sensors may result in greater user engagement, and create opportunities for providing users with more immediate and robust feedback.

Passive Sensors collect data without the user's direct and active participation. In the exemplary embodiment, passive sensors may collect data including the time of data entry, a user's geographic coordinates, and even a tally of the number of data points collected.

The sensors in the system's user interface may be extensively configurable. The system may allow users to configure the titles of the data-capture sensors, as well as the measurement scales used to record the data. The data collected by the system may be non-uniform within a population; that is, different users may enter different types of data into the system, users may measure the same types of data on different scales, and users may enter the same types of data under different labels than other users.

Data capture titles and descriptions that may be configured by a user provide a number of advantages over a static data-entry structure. Many existing models prefer uniform and static data entry to facilitate data comparison across populations. The disclosed system may use either static and uniform or configurable data entry structures. Allowing a user to personalize and tailor data collection methodology to her own preferences tends to encourage assiduous data capture. On the other hand, forcing a non-standard individual into a pre-determined, standardized structure may alienate the individual user and tend to discourage participation in the data capture process.

The initial set of data collection categories may be configured by a coach, for use by the user. A simple topic-configuration may be appropriate for new users. A simple interface facilitates early user engagement. The exemplary embodiment depicted in FIG. 3, includes a simple 3 topic configuration, appropriate for a new user. As a user becomes familiar with the system, additional categories may be added.

When a new data-collection type is added to the system, the system may also prompt the user for information such as “why is this important?” and then accept and record further information from the user. This information is stored in the database, along with passive sensor data. The “why” data may be useful in developing and testing future hypothesis, and reminding the coach and user of when information was believed to be important at what time periods.

Conversely, when a topic is removed from the system, the system may prompt the user for input relating to the rationale behind removing the topic. For example, the system may prompt the user “Why is this topic not important (anymore)?” or “Which hypotheses have been refuted/confirmed?”

While non-uniform data collection may hinder comparisons across populations, it tends to improve data capture for a particular individual, and therefore facilitates comparison of the data relating to that individual across different time-periods.

The user interface design depicted in FIG. 3 is exemplary only. Many other designs are available, and may be appropriate under varying conditions. In addition to rows of buttons associated with text and numbers, the interface may include topics represented by bubbles that change in size, color, position relative to other topics (e.g., float to top), etc.

In a preferred embodiment, the system accepts retroactive changes to user data. The system labels such retroactive changes as out-of-time data, and may also include the modification date (in addition to any other time data collected). The system may prohibit retroactive data entry after a certain time limit has been reached. For example, the system may prohibit retroactive data entry relating to events more than 1 week old.

In another embodiment, the user is only allowed 2 minutes to edit or delete an observation. Such a system incentivizes the user to accurately enter data on the first attempt.

The system can include an expectation relating to the percentage data collected in real-time data collection versus out-of-time data.

Topics and sensors may be interrelated. That is, entering data through one topic-button can result in changes to data across more than one topic.

### Example

Food Sensor

In some embodiments, the system captures data relating to meals eaten by a user. In these embodiments, the system is configurable efficiently capture important meal-related data.

The system may receive image data. For example, it may receive data from a camera or smartphone camera.

FIG. 6 illustrates a preferred embodiment including a food photograph interface 601. A user selects a food sensor button in the system, and then photographs her food 605. The food item is placed in the frame of the camera 603 and photo data is recorded using a photo activation button 607. Addition navigation buttons 609 may be provided to return to the topic interface.

After taking the photograph, the system provides an opportunity for the user to input additional data relating to the meal, for example in a food interface 501, 503. The system provides the user with a configurable array of buttons 505, 506, 509, 511, relating to the topics under examination 513. For example, if a user's gluten intake is under examination, a “gluten” button is provided to easily tag the meal and photograph as containing gluten. Other examples include approximate calorie content, carbohydrate content, sugar content, etc. In some embodiments, the user may input this data by way of text entry, radio buttons, drop-down boxes, scrolling menus and other data entry models.

The system receives the image of the food item as well as the food quality information and meta-data. The system may also receive various passive information relating to the food. Passive information may include, for example, the geographic location of the sensor and the time the information was received.

Recording a first party's photographic meal data provides several advantages over other forms of data entry. For example, it allows a second party to confirm the accuracy of the non-photographic data associated with the food (for example, estimated calorie count, carbohydrate content, etc.). In addition, photographing meals tends to encourages data entry. In some embodiments, a coach reviews the user's meals and associated data.

### Feedback

The system incorporates dynamic user feedback into its data capture systems and user interface. Frequent feedback tends to promote user engagement and more effectively maintain adherence to goals and expectations, and thereby facilitate a desired change in a user's behavior. Dynamic user feedback helps motivate users to continue to engage with the system and participate in the data capture process. The system may include positive-reinforcement feedback when a user meets and expectation. The system may also include warning notifications when the user is not on track to meet expectations.

In a preferred embodiment, topic-buttons include an outline. A user may engage with that topic by selecting the topic-button. A design feature of the button may indicate the status of expectations relating to the topic. For example, certain expectations may be fulfilled, unfulfilled or exceeded. In this embodiment, the color of the button's outline may change to indicate status of the expectation (for example, white for unfulfilled, green for fulfilled and red for exceeded).

When the user meets an expectation related to that topic, the topic-button outline changes color. In other embodiments, when a user meets a topic-expectation, the system may, for example, change the size of the topic-button, change its shape, shading, color and/or change its location with respect to other topic-buttons.

The system may include warning notifications when the user is not on track to meet an expectation. In one embodiment, a user has an expectation of drinking 2 liters of water per day. In this embodiment, the system separates the day and the expectation into quarters (i.e., 0.5 liters of water every 6 hours), and then compares the received user data to the quarterly-expectations at quarterly time intervals, and then notifies the user if the received user data does not meet the quarterly expectation.

### Coach Interface

In a preferred embodiment, the disclosed system provides an interface for analysis of the captured data. The analysis interface provides views that enable users to make identify correlations and to make inferences about the causal relationships among the data. The analysis interface synthesizes and summarizes data collected by the system. The system may provide sub-modules for drilling down into specific data entry categories and instances.

In some embodiments, this interface is used by a coach to sets initial topics and expectations for the user, and then to review and analyze the collected data. The analysis interface may allow a user to select various topics and to chart and compare the related data across time and among populations of users. The analysis interface also allows a user to review images captures by the user, and to sort and compare the images based on the related meta-data.

The analysis interface may accept certain data from a user. For example, it may allow the user to enter notes and comments regarding data and potential hypothesis. The analysis interface may also allow the user to tag data with additional meta-data and to correct erroneous entries. The analysis interface may also accept comments from a first user to be passed on to a second user.

Automation and organization increases efficiency, allowing coach to work with more clients per day. Coach can review client's data before scheduling meeting. If there is no available data to discuss, meeting can be cancelled. If data suggests a detailed conversation is required, coach can schedule a longer meeting.

### Server

The system stores received data on a standard database. In a preferred embodiment, the database is a NoSQL database hosted on a web-based “cloud” server. In other embodiments, the database may be any other database type, for example, MySQL, Microsoft Access, Oracle, and may be hosted locally or remotely.

### Multivariate Analysis

The network of potential causes underlying the target physical or mental conditions can be complex. Isolating the cause of a physical or mental condition is often a difficult task, in particular when there is a long time delay between the cause and effect. Problems of dynamic complexity and feedback loops can further complicate the problem. The disclosed technology provides a system for assessing several competing hypotheses.

Where several hypotheses are developed, the disclosed system may arrange the hypothesis into a matrix. The matrix structure facilitates comparison between competing hypothesis. A matrix structure for the analysis of competing hypothesis is disclosed in Psychology of Intelligence Analysis, Richards J. Heuer, Jr. (Center for the Study of Intelligence, Central Intelligence Agency, 1999) and hereby incorporated by reference (specifically, see chapter 8, “Analysis of Competing Hypotheses”).

In some embodiments, the matrix lists hypotheses across a first axis, and topics or expectations across a second axis. Competing hypothesis may be tested using either existing historical data (from the user, the population or both) or by gathering new evidence.

After data relating to the topic has been monitored and collected, certain hypothesis may be proven (true), disproven (false) or remain unproven (inconclusive). The disproven hypothesis may be removed, iterated, updated or altered. Topics and expectations may be adjusted to reflect the new set of hypotheses and the user can begin to monitor and capture new data.

The following provides an example of a series of iterated hypotheses, evidence collection, experiments and results. In this example, a user suffers from lupus as well as 20 other diagnoses. Entries are labeled with the following shorthand notation: H: hypothesis; E: evidence; X: experiment.

H1: User is drinking too little pure water;
E1: User's urine is dark yellow;
E2: User is taking a handful of medication a day;
E3: User is drinking more tea and soda than pure water a day (tracked with Tea and Soda topics);
H2: User's body does not get enough pure water to process the meds;
X1: Increased water intake will make urine less yellow and improve overall wellbeing.

To implement the X1 experiment, a “Water” topic with expectation of 1.4 liters per 24 hours is added to the user's topic configuration. The data captured by the system indicates that the user fulfilled the “water expectation” consistently for 3 days. The data also indicates that the user's urine became a normal yellow color. The example continues below:

H4: User experiences excess mucus/runny nose after eating nightshades;
E4: User's Food observations show that intake of nightshades most times is followed by runny nose within 30-45 minutes;
H5: User's lupus pain could be associated with intake of nightshades;
X2: Eliminate nightshades from User's diet;

To implement the X2 experiment, a “Nightshades” sensor is added to “Food” topic to raise User's awareness of nightshade intake and to gather data about actual intake. The data captured by the system indicates that the frequency of runny nose within an hour of eating decreased substantially during the X2 experiment. During a particular week, 4 out of 5 residual instances were in connection with intake of nightshades. In addition, the data indicated that the average number of lupus pain observations decreased from 6 per week with an average severity score of 3.75 (out of 5) to 2 per week with an average severity score of 2.5 (out of 5). The experiment continues below with another iteration:

H6: The residual instances of runny nose are caused by a heightened sensitivity of the User's digestive system
X3: Eliminate additional potentially adverse foodstuff from User's diet

The system supports the coach and/or the User in refuting or confirming hypotheses by looking at which hypotheses have not been associated with evidence and then prompting users for hypotheses statements accordingly.

Some embodiments of the system use timestamps of the hypothesis statements to tell the story of the changing hypothesis matrices.

The system may analyze population data (data captured across a plurality of users). Based on the data gathered from previous Users the system may algorithmically propose pre-defined hypothesis matrices that may be relevant to a particular user. These pre-defined matrices can be used to seed and accelerate the process of isolating a causal factors affecting the user's condition.

### Storyline/Data Stream

Some embodiments provide output in the form of an individual user's data stream. Some embodiments provide output in the form of a collective data stream, aggregated across a population. Some embodiments provide both types of output.

FIG. 7 depicts an exemplary user data stream, showing events relating to topics, expectations, and statements. In some embodiments, the storyline stream depicts the newest item at the bottom. This makes it possible to read the stream from top to bottom, like a story. Reading in chronological order also supports the analysis of dynamic complexity. That is, looking for causes and effects that are separated in time and location.

The storyline stream can include all timestamped data for a user or may be filtered to display only certain data based on criteria set by the coach, e.g. only topics configuration changes and changes to the hypothesis set.

In some embodiments, the system also provides a population data stream. The client-population-stream supports a coach or a team of coaches in managing the data-driven coaching of a population of clients. The client-population-stream may include a series of system-generated statements describing various aspects of the aggregate state of users across the population, and possible interventions. These statements may include visual representations of the state of a user, a group of users, or the entire population of users. Visual representations may include graphs, charts, sparklines, photographs, and other visual representations. Visual representations can quickly provide a coach with context for a particular statement, where a number alone may not.

Data in a population-data-stream might include, for example:
a. The system has not received any observations from client NN for 24 hours (this could indicate that the client has not made any observations or that there is a technical issue).
b. The expectation on client NN's “Water” topic has not been fulfilled 4 out of the last 7 days.
c. Client NN's hypothesis set has not changed for the last 4 weeks.

The system-generated statements for aggregate data may be linked to relevant content in a particular user's data stream, and may allow a coach to directly contact the relevant user (for example, by text message, or an email, phone or other communication).

The disclosed embodiments are illustrative, not restrictive. While specific configurations of the monitoring and collaboration technology have been described, it is understood that the present invention can be applied to a wide variety of collaborative monitoring technology. There are many alternative ways of implementing the invention.

Examples are non-limiting. The phrase “for example” means “for example, one of many possible embodiments includes:” In addition, Lists are intended to be non-limiting. The word “including . . . ” or “includes . . . ” shall mean “including but not limited to . . . ” and “includes but is not limited to . . . ”.

What is claimed is:

1. A computer-implemented method, comprising:
a. receiving at least a target condition related to a first user,
b. receiving at least a potential-causal-relationship between a topic and the target condition,
c. providing a first-user interface for a first user, wherein the first-user interface is configured to accept at least an observation relating to the topic,
d. receiving at least one observation relating to the topic,
e. associating the observation with the potential causal relationship,
f. providing a second-user-interface for a second user, wherein the second-user-interface is configured to display the observation and associated potential-casual-relationship.

2. The computer-implemented method of claim 1, further comprising:
a. arranging the topic and potentially-causal relationship in an analysis of competing hypothesis matrix.

3. The computer-implemented method of claim 1, further comprising:
a. providing a button representing the topic, and wherein
b. the button includes a topic-description, a topic-value along a scale, an outline and a state-value with respect to the comparison between the expectation and the topic-value.

4. The computer-implemented method of claim 3, further comprising:
a. Providing feedback to the first user through the first-user interface by changing the physical representation of the button to correspond to the state-value.

5. The computer-implemented method of claim 4, wherein,
a. The change in the physical representation of the button is a change in the color of the button's outline.

6. The computer-implemented method of claim 3, further comprising:
a. the topic-description and topic scale are user-configurable.

7. The computer-implemented method of claim 1, further comprising:
a. recording the time at which data is collected and associating the time value with the collected data.

8. The computer-implemented method of claim 1, further comprising:
a. recording a geolocation value at which topic-data is collected and associating the geolocation value with the topic-data.

9. The computer-implemented method of claim 1, further comprising:
a. receiving photographic data relating to a topic, and
b. associating the photographic data with the topic.

10. A computer system comprising,
a. a first user interface, a second user interface, and a server; wherein
b. the system receives at least one potentially-causal relationship between a target condition affecting a first user and a topic;
c. the second user interface receives, from a second user, at least one expectation relating to the second condition,
d. the first user interface receives data relating to the expectation,
e. the system compares the data to the expectation,
f. the second user interface makes the data and the results of the comparison available to a second user through the second-user interface.

11. The system of claim 10, wherein,
a. the second user interface arranges at least one topic and at least one potentially-causal relationship in an analysis of competing hypothesis matrix.

12. The system of claim 10, wherein,
a. The first-user interface includes at least a button, and wherein the button includes a topic-description, a topic-value along a scale, an outline, and a state-value with respect to the comparison between the expectation and the topic-value.

13. The system of claim 12, wherein,
a. the topic-description and scale are user configurable.

14. The system of claim 11, wherein,
a. The first-user interface provides feedback to a first user by changing the physical representation of the button to correspond to the state-value.

15. The system of claim 14, wherein,
a. A change in the topic's state value causes a corresponding change to the color of the button's outline.

16. The system of claim 10, wherein,
a. the system records the time at which data is collected and associated the time value with the collected data.

17. The system of claim 10, wherein,
a. the system records geolocation data at which the topic-data is collected and associated the geolocation-data value with the topic-data.

18. The computer system of claim 10, further comprising a camera, wherein,
a. at least one button is associated with the camera,
b. selecting said button activates the camera,
c. the system receives photographic data and associates the data with a topic.

19. The computer system of claim 18, further comprising,
a. at least one button for accepting meta-data relating to the photographed object.
